(19) United States
(12) Patent Application Publication
(10) Pub. No.: US 2012/0110492 A1
(43) Pub. Date: May 3, 2012

(54) METHOD AND SYSTEM FOR TIME SHEET MESSAGING

(76) Inventors: Sandeep Subhash KHABIYA, Cupertino, CA (US); Subir Parulekar, Cupertino, CA (US)

(21) Appl. No.: 12/914,459

(22) Filed: Oct. 28, 2010

(51) Int. Cl. G06F 3/048

(52) U.S. Cl. 715/772

(57) ABSTRACT

A method and system for time sheet messaging is presented. The method includes providing a time-sheet application for managing a plurality of projects, each project associated with at least one organizational unit. A graphical user interface is provided which includes a time-sheet information area for display and entry of time sheet data for a project, and a concurrently displayed message area for display of messages. An affiliation of a current user of the graphical user interface with an organizational unit is identified. A message intended for the current user is selected for display in the message area, based on the identified affiliation of the current user. A system and a computer program product are also presented.

### BACKGROUND

An organization or workplace may utilize a time sheet program or application to enable reporting and/or reviewing the time that an employee worked on various tasks or projects. Use of such a time sheet application may enable time reporting in an efficient and effective manner. For example, use of a time sheet application may enable an employee to report time worked in real time (e.g., by reporting a time when the employee begins and/or finishes working on a job or task), or immediately after performing a job or task.

One or more users of the application within the organization may be designated as supervisory users and/or policy setters. Policy setters may include representatives of management, of a human resources department, and/or of an accounting or payroll department. For example, a policy setter may determine which employees may be authorized to report time worked on a particular project, or how much each employee may be authorized to report against a project. A policy setter may set priorities among various projects.

A policy setter and/or other supervisory user may find it necessary from time to time to communicate with an employee, and/or a group of employees, regarding issues related to time reporting. For example, the policy setter may need to communicate with an employee to inform the employee regarding a change in policy or priorities.

Such communication can take place via such channels as meetings, telephone calls, memos, or email messages. An employee receiving a message related to use of the time sheet application may then be responsible for recalling the contents of the message at a later time or date, when interacting with the time sheet application.

### BRIEF DESCRIPTION OF THE DRAWINGS

FIG. 1 illustrates schematically a system for time sheet messaging in accordance with an embodiment of the invention;

FIG. 2 illustrates schematically a graphical user interface for time sheet messaging in accordance with an embodiment of the invention;

FIG. 3 is a flow chart of a method for time sheet messaging in accordance with an embodiment of the invention; and

FIG. 4 is a flow chart of a method for time sheet messaging in accordance with an embodiment of the invention.

### DETAILED DESCRIPTION

A method and system of time sheet messaging in accordance with embodiments of the invention may include providing a message area on a graphical user interface (GUI) of a time sheet application. The time sheet messaging GUI may be designed to be accessible by a user. Users may include various employees of an organization, including management, supervisory, and/or policy setting personnel.

The time sheet messaging GUI of the time sheet application may include a time sheet information area. The time sheet information area may be configured to provide time-sheet application functionality. Time sheet application functionality may include functions such as, for example, displaying, entering, modifying, and/or analyzing time sheet data. Typically, an employee or other reporting user may use the time sheet area of the time sheet messaging GUI to enter and/or review time worked on a task and/or project. A supervisory user may typically use the time sheet area of the GUI to review time reported by a reporting user, and/or by a group of reporting users.

In an embodiment in accordance with the invention, the message area may be configured to display one or more messages. A message may be generated by a user of the time sheet messaging GUI. A user of the time sheet messaging GUI may generate a message intended to be displayed to another user.

A current user of the time sheet messaging GUI may be identified during the course of logging onto a system capable of running the time sheet messaging GUI. Identification of the current user may enable the identification or determination of one or more organizational units with which the identified user is affiliated. An organizational unit may include a group of personnel who are authorized to work on, or to log or bill time against, a particular task or project. An organizational unit may include a department or other unit in a hierarchal personnel structure of a company, corporation, or organization. In order to identify such affiliations, a time sheet messaging application may access a database and/or table of users. The database of users may include information that may enable determination of the affiliation(s) of each user with one or more of the organizational units.

In accordance with an embodiment of the invention, a message may be selected for display in the message area of the time sheet messaging. Selecting the message may include consideration of any identified affiliations of the current user with an organizational unit. For example, a message may be selected for display when the current user is identified as being affiliated with a particular organizational unit.

A policy setting user such as a manager, supervisor, or other policy setting personnel of an organization may generate a message. The message may include instructions intended for a reporting user who is affiliated with a particular project or other organizational unit. For example, the policy setting user who may generate the message may designate users who are affiliated with the particular organizational unit to be the intended recipients of the message. When one of the intended recipient users is identified as accessing the GUI, the GUI may then display the message in the message area.

In accordance with an embodiment of the invention, a user accessing the GUI may generate a message for receipt by a supervisory user. For example, a reporting user may generate a message that may contain a request and/or query (e.g., requesting an explanation or instructions) that may be intended to be displayed to the supervisory user. The supervisory user, upon receiving the querying message, may generate a responding message (e.g., containing a reply or instructions) that may be intended for display to the querying user alone, or to a group of users to whom the response may be of interest. A reporting user using the time sheet messaging GUI to enter time sheet data may generate a message (e.g., containing explanatory information) intended for display to a supervisory user who may review the entered time sheet data.

In accordance with an embodiment of the invention, displayed messages may be displayed in an order determined in accordance with criteria. For example, each displayed message may be assigned a priority or importance. The priority may be assigned on the basis of the types and/or numbers of affiliations of a current user of the time sheet messaging GUI with various organizational units. Messages may be displayed in the message area of the time sheet messaging GUI such that a message with higher priority may be displayed more prominently than a message with lower priority. Messages that were generated in response to previously generated messages may be displayed so as to indicate the interrelationships among the messages.

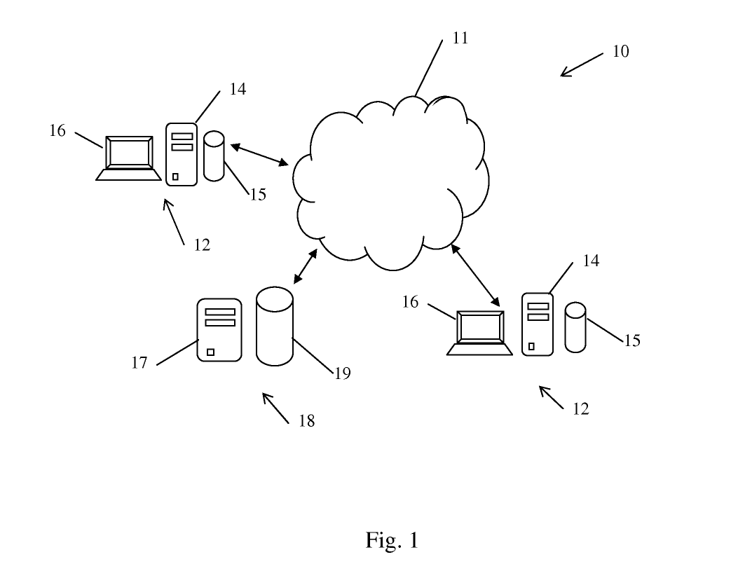

FIG. 1 illustrates time sheet messaging system 10 for time sheet messaging in accordance with an embodiment of the invention. Time sheet messaging system 10 may include one or more stations 12. Each station 12 may include a processor 14 and an input/output device 16. Each station 12 may also include a data storage device 15 that may be associated with and accessible via processor 14. Data storage device may include any volatile or nonvolatile memory device. One or more components of a time sheet messaging application may be stored on data storage device 15.

Stations 12 may communicate with one another via network 11. Time sheet messaging system 10 may also include a server 18 that may communicate with stations 12 via network 11. In accordance with an embodiment of the invention, the functionality of server 18 may be distributed among some or all of stations 12.

Station 12 may include a multipurpose workstation. For example, station 12 may include a stationary or portable computer that may serve as a user workstation. Processor 14 of station 12 may include a programmable mobile or stationary computer processing unit and associated memory and interface devices. Input/output device 16 may include computer input and output devices such as a display screen, speaker, a keyboard, a keypad, a pointing device, and/or a touch screen. A user may operate station 12 to access a time sheet messaging GUI of a time sheet messaging application. For example, the user may cause a time sheet messaging application to run on processor 14 of station 12, or access via station 12 and network 11 a time sheet messaging application that may be running on a remote processor. A user may be identified either during an operation of logging on to the workstation, or when accessing the time sheet messaging GUI. For example, the user may enter a user name and password.

In accordance with an embodiment of the invention, station 12 may include a dedicated station. For example, station 12 may be associated with a time clock device. Processor 14 of a dedicated station may include, for example, a local or remote processor associated with a time clock device. Input/output device 16 may include a device for reading user-identifying information. A user may activate the dedicated station by entering identifying information. For example, the device may include a physical keyboard, or a virtual keyboard and a pointing device, for entering characters of a name or an identifying number or code, a sound sensor (e.g., microphone and sound analysis application) for entering orally spoken information, a scanner for reading biometric data, or a device from reading encoded identifying information from a portable identifying device such as a card, badge, or key. A portable identifying device may include encoded identifying information in the form of, for example, scannable text, a bar code, a magnetic strip, or a radio frequency identification device. Input/output device 16 may include a screen for displaying the GUI.

In accordance with an embodiment of the invention, station 12 may be configured to be operated by a reporting user who may use the time sheet GUI to report hours worked. Another station 12 may be configured to be used by a supervisory user who may use the time sheet GUI to read, process, and/or forward, hours worked that were reported by reporting users. A station 12 may be configured for operation by any type of user, with the GUI being adapted to an identified current user.

Network 11 may include any type of communications between stations 12 suitable for time sheet management and messaging. For example, network 11 may include hard-wired interconnections among stations 12. Such interconnections may be typically suited to dedicated stations. Alternatively, network 11 may include any type of wired, wireless communication, and/or electronic data network. For example, network 11 may include the Internet, an intranet, or a telephone network.

Station 12 may communicate via network 11 with server 18. Server 18 may include processor 17. Server 18 may also include a data storage capability such as data storage device 19. Data storage device 19 may provide storage for a database. The database may include stored data concerning organizational affiliations of various users. Data storage device 19 may also include stored data that may describe the contents and/or intended recipients of messages. Processor 17 may control access to data stored on data storage device 19 in accordance with predetermined rules.

In accordance with an embodiment of the invention, processor 17 may be configured to run some or all components of a time sheet messaging application. A user operating a time sheet messaging GUI on station 12 may communicate with the time sheet messaging application running on processor 17 of server 18. In another implementation, a time sheet messaging application may run locally on processor 14 of station 12. The time sheet messaging application running on station 12 may access data storage device 19 via network 11. Some or all components of a time sheet messaging application running locally on processor 14 of station 12 may be installed via communication with server 18.

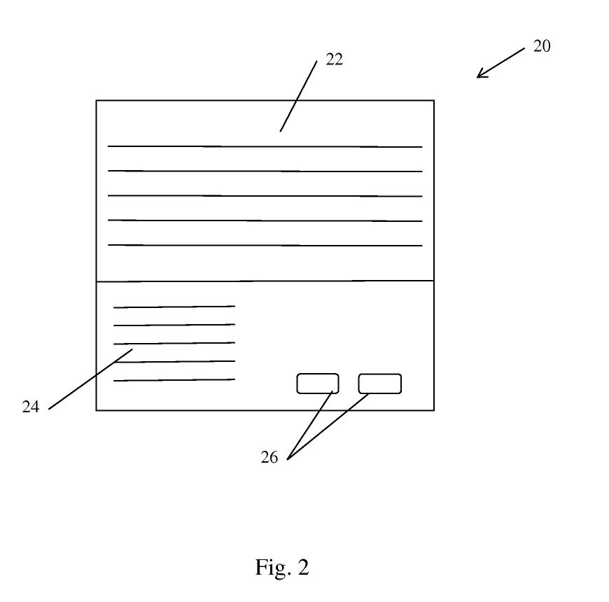

Input/output device 16 of each station 12 may enable a user to access a time sheet messaging GUI of a time sheet messaging application. FIG. 2 illustrates schematically time sheet messaging GUI 20 in accordance with an embodiment of the invention. Time sheet messaging GUI 20 may include time sheet information area 22, and message area 24. In addition, time sheet messaging GUI 20 may include one or more controls 26. FIG. 2 representatively illustrates time sheet information area 22 and message area 24 as separate specific regions of a single displayed GUI. However, alternative equivalent arrangements of time sheet information area 22 and message area 24 are possible. Furthermore, each of time sheet information area 22 and message area 24 may include a plurality of noncontiguous regions of time sheet messaging GUI 20. For example, a message may be relevant to particular time sheet data regarding a particular project that may be displayed in time sheet information area 22. In this case, the message relevant to the particular time sheet data may be displayed in a region of the message area that is juxtaposed with a region of the time sheet information area where the particular time sheet data is displayed.

Alternatively, time sheet information area 22 and message area 24 may be displayed on separate screens. A dedicated station may include adjacent devices with separate displays and input devices: one that may include time sheet information area 22, and another that may include message area 24.

In an embodiment, time sheet information area 22 and message area 24 may be represented by non-visible presentation of data. For example, time sheet information area 22 and message area 24 may be rendered audibly or palpably, e.g., for use by a vision-impaired user.

Controls 26 of time sheet messaging GUI 20 may include various physical and virtual (on-screen) controls associated with a station 12. For example, station 12 may include a touch-sensitive button. Virtual controls, such as screen buttons, slide bars, or menus, may be accessible via a physically manipulable pointing device, and/or via a touch screen. Virtual controls may be located within time sheet information area 22 and message area 24. Time sheet information area 22 and message area 24 may be in the same part of the display.

Time sheet information area 22 may enable entering and/or reviewing time sheet information. A time sheet application may adapt time sheet information area 22 to a particular identified current user. For example, if the current user is identified as a reporting user, time sheet information area 22 may enable specifying a project and the amount of time worked on the project. Time sheet information area 22 may also enable reviewing time sheet data that was previously entered by the current user. If the current user is identified as a supervisory user, time sheet information area 22 may enable the current user to review time sheet data that was previously entered by several reporting users. Time sheet information area 22 may also enable a supervisory user to extract time sheet data for reporting to another entity (e.g. an accounting or payroll department).

Message area 24 may enable a user to review messages that were generated by other users. When a current user of time sheet messaging GUI 20 is identified, a time sheet messaging application may search a message repository for messages that are intended for the current user. Messages intended for the current user may then be displayed in message area 24. The form of the messages displayed in message area 24 may depend on such factors as the number of messages to be displayed, and/or the relative priority of each message. For example, if a small number of messages are to be displayed, each message may be displayed in its entirety. If a large number of messages are to be displayed, space limitations may limit the portion of the message that is displayed (e.g., to a title, a first line, and/or a first few lines). If a message to be displayed has been assigned a higher priority than other messages to be displayed, the higher priority message may be displayed more prominently, or more fully, than the other messages. A message may be prominently displayed at the top of message area 24, or otherwise made distinguishable by being displayed in a larger or bolder font, and/or by being tagged with a symbol or label indicating high priority.

The form of the messages displayed in message area 24 may depend on the identity of the user. For example, if the current user is identified as a reporting user, the messages may be limited messages intended for those organizational units with which the current user is affiliated (e.g., a project, a department, etc.). If the current user is identified as a supervisory user, messages related to organizational units that the current user supervises may be displayed.

The form of the messages displayed in message area 24 may also depend on actions of a current user. For example, if a particular project is selected in time sheet information area 22, only those messages related to the selected project may be displayed. Messages related to a selected project may be displayed more prominently than other messages. Selection of a message in message area 24 may limit the displayed messages to those messages that were generated in response to, or as part of the same discussion thread as, the selected message. Alternatively, the related messages may be displayed more prominently or in such a manner (e.g., in a hierarchal arrangement) so as to illustrate any interrelationships among the displayed messages.

A user may operate message area 24 of time sheet messaging GUI 20 to generate a message. For example, a user may operate control 26 to initiate generation of a generated message. A generated message may be generated in response to a received message, or as an independent new message. Content of a message may be generated, for example, by using a physical keyboard or using a pointing device to select characters or symbols from on-screen character set.

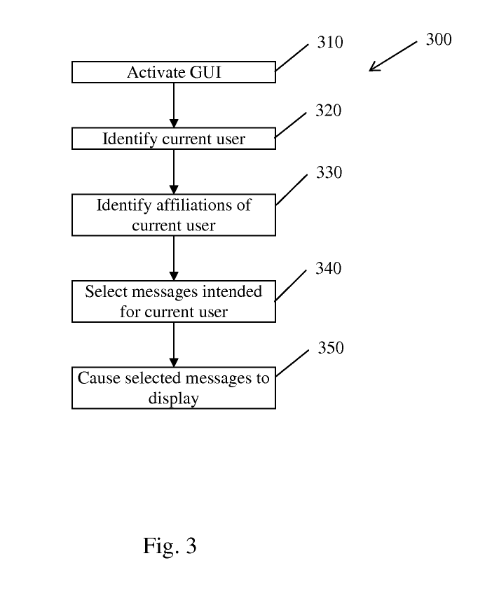

FIG. 3 depicts method 300 for time sheet messaging in accordance with an embodiment of the invention. It should be understood with regard to this flowchart, and with regard to all flowcharts herein described, that the division of the method into discrete steps is for convenience and clarity only. Alternative division of the method into steps is possible with equivalent results, and all such equivalent divisions into should be understood as included within the scope of embodiments of the present invention. The order of the steps illustrated in the flowcharts is selected for the sake of convenience and of clarity. Steps of the method may be performed concurrently or in an alternative order with equivalent results unless specifically identified otherwise. Such reordering of the steps should be understood as included within the scope of embodiments of the invention.

In the discussion of the flowchart of FIG. 3, reference is also made to components of the system shown in FIG. 1 and of the GUI shown in FIG. 2.

A current user may operate a time sheet messaging application in accordance with an embodiment of the invention so as to activate a time sheet messaging GUI (step 310). The time sheet messaging application may include a capability of managing a plurality of projects. A current user may operate an input/output device 16 of station 12 in order to activate time sheet messaging GUI 20. For example, components of time sheet messaging GUI 20 may be displayed on a display screen of input/output device 16. The time sheet messaging GUI may include a time sheet information area for entering or reviewing time sheet data related to the various projects being managed by the time sheet application. In addition, the time sheet messaging GUI may include a message area the enables the display of messages.

Activation of the time sheet messaging GUI may include identifying the current user (step 320). As part of activation of the time sheet messaging GUI, the user may enter identifying information, such as a name, user name, and/or user identification number. Identification may also include verifying identification by having the user enter a password or code, biometric data, or by use of an identification device, such as a key or a scannable badge, card, or tag. The time sheet messaging GUI may compare the entered identification information with user information that may be stored within time sheet messaging system 10. When the entered information matches stored identification that is associated with a particular user, the current user may be identified as that particular user.

The time sheet messaging application may identify organizational units with which the current user is associated and/or affiliated (step 330). For example, data storage device 19 of a server 18 of time sheet messaging system 10 may include stored information that connects a current user to one or more organizational units. Information may indicate that the current user may be a member of a department of an organization or may report to a particular manager. In such a case, the current user may be identified as affiliated with that department or manager. As another example, the information may indicate that the current user may be authorized to report time against a particular project. In this case, the current user may be identified as affiliated with that project.

The time sheet messaging application may then select any messages that may be intended for the current user (step 340). Typically, messages may be stored in one or more message repositories. For example, a message repository may be associated with data storage device 19. A stored message typically may include information regarding an intended recipient or addressee of the message. Information regarding intended recipients may be stored in a header or other section of the message itself, in a separate table, and/or other index. An intended recipient may include a particular user, and/or a particular organizational unit. If the current user is identified with the particular user, or is identified as being affiliated with the particular organizational unit, the current user may be identified as an intended recipient of the message. When the current user is identified as an intended recipient of the message, the message may be selected.

The time sheet messaging application may then cause the selected messages to display in a message area of time sheet messaging GUI 20 (step 350). At least some of the selected messages may be displayed concurrently with the time sheet information area of the time sheet messaging GUI. The current user may view or refer to a message when entering or reviewing time sheet data. For example, if a message includes instructions regarding the entry or application of time sheet data, the instructions may be visible to the user when the instructions are needed.

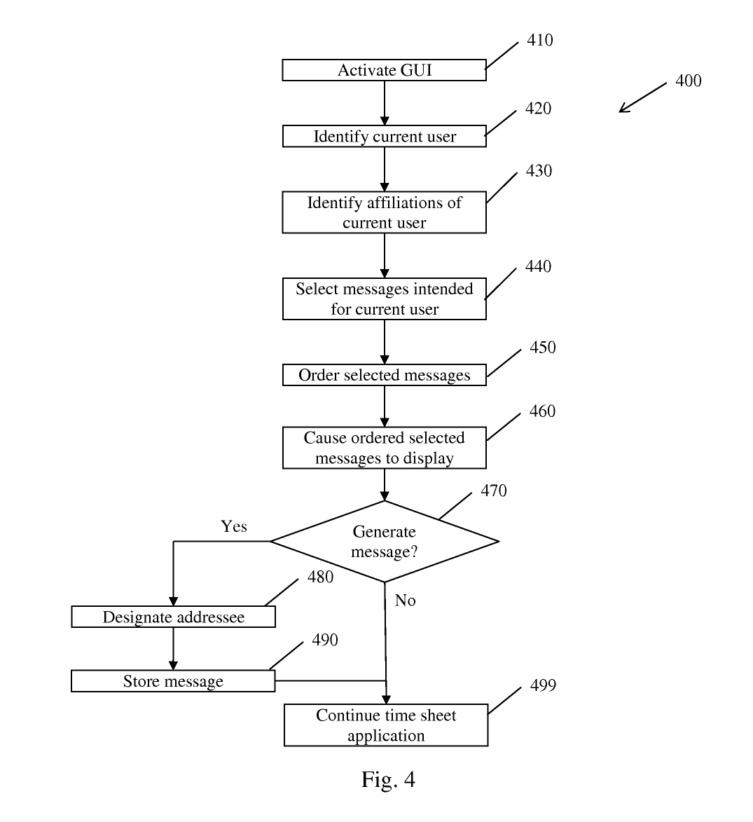

FIG. 4 depicts method 400 for time sheet messaging in accordance with an embodiment of the invention. Steps 410-440 of method 400 may be similar to steps 310-340 of method 300, and are briefly discussed here. A current user may activate a time sheet messaging GUI (step 410), enter identification information (step 420), upon which the current user's affiliations may be identified (step 430). A message for which the identified current user may be an intended recipient may then be selected (step 440).

The time sheet messaging application may then assign an order, and/or a priority, to selected messages when more than one message is selected (step 450). A priority of a message may be based on an urgency and/or an importance factor associated with the message. The factor may have been assigned by a user who generated the message, or automatically by the time sheet messaging application in accordance with predetermined criteria. The priority may be assigned on the basis of a current context. For example, when a particular project is selected in the time sheet information area of the time sheet messaging GUI, the priority of the message may increase. The priority may change dynamically during the course of user interactions with the time sheet messaging GUI.

In accordance with an embodiment of the invention, a priority may be assigned on the basis of a series of factors. In one implementation, these series of factors may be listed in decreasing order of relevance.

Exemplars of the factors may include:
1. Whether the message recipient is a user affiliated with a currently selected project.
2. Whether the message recipient is a user affiliated with a broader project of which the currently selected project is a subproject.
3. Whether the message recipient is a user affiliated with a particular organizational unit (e.g. department).
4. Whether the message recipient is a current time period.
5. An assigned priority of a message.
6. Recentness of the message (e.g., a recently generated and/or received message may be assigned a priority greater than an earlier message).

Priorities may also be assigned on the basis of user reactions to the message. A messaging area of the time sheet messaging GUI may enable a user to enter a rating for a message that may be displayed in the message area.

In an embodiment in accordance with the invention, messages may be ordered on the basis of relationships among messages. Messages that may be part of a single thread (messages written in response to, or in reaction to, earlier messages) may be organized in chronological or similar order. A hierarchal arrangement of the messages may evince interrelationships among the messages.

A message that is received while the user is using the time sheet messaging GUI may be displayed in its assigned order in the message area. Alternatively, a received message may be prominently displayed upon receipt at least temporarily for a predetermined period of time.

A time sheet messaging GUI in accordance with an embodiment of the invention may display the selected messages such that the prominence of the display of each message is related to the assigned order or priority (step 460). A high priority message may be displayed in the message area closer to the top of a list of messages than a lower priority message. In another implementation, a message with relatively high priority may be displayed in a bolder and/or larger font. Also its importance may be indicated by an associated symbol, character, and/or text. In another implementation, a message assigned a high priority may be automatically opened (displaying the full text of the message), while a message with a lower priority is closed (displaying only a title, subject, or first words).

Messages ordered on the basis of interrelationships among the messages may be displayed such as to make evident the interrelationships (discussion thread).

The current user may decide to generate a message (step 470). A generated message may be generated in response to a received message (e.g., an answer to a question, a request for clarification, etc.). A user may generate a new message (e.g., an instruction, question, etc.).

The message may be assigned an intended recipient or addressee (step 480). For example, a user who may generate a message may designate an intended recipient of the message. The intended recipient may be an individual user, an organizational unit, and/or other group of users. In another implementation, the time sheet application may automatically designate a recipient based on contextual and/or other information. A question for clarification based on a received message may be automatically addressed to either the user who generated the received message, and/or to all intended recipients of the received message. In another implementation, a message generated in the context of a particular organizational unit such as a project (e.g., the project being selected at the time that the message was generated), may be automatically addressed to users affiliated with that project.

The generated message may be stored, e.g., in a message repository (step 490). The message may be retrieved from storage when an intended recipient accesses the time sheet messaging GUI.

Whether or not the user generated a message, the user may continue to operate the time sheet messaging GUI (step 499). For example, the user may enter or review time sheet data.

Time sheet messaging, according to an embodiment of the invention, may be implemented in the form of software, hardware or a combination thereof.

Embodiments of the invention may be in the form of a system, a method or a computer program product. Embodiments of the invention may be implemented in hardware, software or a combination of both.

Embodiments of the invention may be in a computer program product saved on one or more computer readable medium (or mediums) in the form of computer readable program code embodied thereon. The computer readable medium may be a computer readable storage medium. A computer readable storage medium may be a non-transitory media, for example, an electronic, optical, magnetic, electromagnetic, infrared, or semiconductor system, apparatus, or device, or any combination thereof.

The computer readable medium may be associated with a server or other remote computer or processor. An installation, executable, file in compressed format, or other file enabling installation or execution of the file on a remote medium may be accessible by a local computer or processor via a network or other remote connection.

Computer program code in embodiments of the present invention may be written in any suitable programming language. The program code may execute on a single computer, or one a plurality of computers.

While there have been shown and described fundamental novel features of the invention as applied to several embodiments, it will be understood that various omissions, substitutions, and changes in the form, detail, and operation of the illustrated embodiments may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

We claim:

1. A computer implemented method comprising:
providing a time-sheet application for managing a plurality of projects, each project associated with at least one organizational unit;
providing a graphical user interface which includes a time-sheet information area for display and entry of time sheet data for a project of said plurality of projects, and a concurrently displayed message area for display of messages;
identifying an affiliation of a current user of the graphical user interface with an organizational unit of said at least one organizational unit; and
selecting for display in the message area a message intended for the current user based on the identified affiliation of the current user.

2. The method of claim 1, comprising generating a message for an intended recipient.

3. The method of claim 2, wherein the generated message is generated as a response to said message intended for the current user.

4. The method of claim 1, wherein selecting a message for display includes assigning a priority to the selected message.

5. The method of claim 1, comprising causing the selected message to be displayed in the message area.

6. The method of claim 5, wherein a higher priority message is displayed more prominently than a lower priority message.

7. The method of claim 5, wherein messages are displayed in a hierarchal arrangement.

8. A non-transitory computer readable medium having stored thereon instructions which when executed by a processor cause the processor to perform the method of:
providing a time-sheet application for managing a plurality of projects, each project associated with at least one organizational unit;
providing a graphical user interface which includes a time-sheet information area for display and entry of time sheet data for a project of said plurality of projects, and a concurrently displayed message area for display of messages;
identifying an affiliation of a current user of the graphical user interface with an organizational unit of said at least one organizational unit; and
selecting for display in the message area a message intended for the current user based on the identified affiliation of the current user.

9. The non-transitory computer readable medium of claim 8, further including generating a message for an intended recipient.

10. The non-transitory computer readable medium of claim 9, wherein the generated message is generated as a response to said message intended for the current user.

11. The non-transitory computer readable medium of claim 8, wherein selecting a message for display includes assigning a priority to the selected message.

12. The non-transitory computer readable medium of claim 8, further including causing the selected message to be displayed in the message area.

13. The non-transitory computer readable medium of claim 12, wherein a higher priority message is displayed more prominently than a lower priority message.

14. The non-transitory computer readable medium of claim 12, wherein the message is displayed in a hierarchal arrangement.

15. A data processing system comprising:
a processing unit in communication with a computer readable medium, wherein the computer readable medium contains a set of instructions, and the processing unit is configured to carry out the set of instructions to:
provide a time-sheet application for managing a plurality of projects, each project associated with at least one organizational unit;
provide a graphical user interface which includes a time-sheet information area for display and entry of time sheet data for a project of said plurality of projects, and a concurrently displayed message area for display of messages;
identify an affiliation of a current user of the graphical user interface with an organizational unit of said at least one organizational unit; and
select for display in the message area a message intended for the current user based on the identified affiliation of the current user.

16. The system of claim 15, wherein the processor is configured to enable selection of a project of said plurality of projects.

17. The system of claim 16, wherein processor is configured to assign a priority to the message selected for display based an association of the message with the selected project.

18. The system of claim 15, wherein the processor is configured to enable generating a message for an intended recipient.

19. The system of claim 18, wherein the processor is configured to enable assigning a priority to the generated message.
